(19) United States
(12) Patent Application Publication
(10) Pub. No.: US 2019/0219857 A1
(43) Pub. Date: Jul. 18, 2019

(54) SURFACE TREATMENT METHOD OF SUBSTRATE, SUBSTRATE, AND LIQUID CRYSTAL DISPLAY PANEL

(71) Applicant: Shenzhen China Star Optoelectronics Technology Co., Ltd., Shenzhen (CN)

(72) Inventor: Qian LI, Shenzhen (CN)

(21) Appl. No.: 16/011,654

(22) Filed: Jun. 19, 2018

Related U.S. Application Data
(63) Continuation of application No. PCT/CN2018/077099, filed on Feb. 24, 2018.

(30) Foreign Application Priority Data
Jan. 12, 2018 (CN) 201810034095.7

(51) Int. Cl. G02F 1/1337; G02F 1/1335

(52) U.S. Cl. CPC G02F 1/13378; B05D 1/18; G02F 1/133514

(57) ABSTRACT

A surface treatment method of a substrate, a substrate, and a liquid crystal display panel are disclosed in the present disclosure. The treatment method of substrate surface includes: providing a substrate; providing a first solution containing a compound with a phosphate group, wherein a first functional group of the compound with the phosphate group is a rigid molecular group containing at least one of hydroxyl, amidogen, and carboxyl; immersing the substrate into the first solution for performing a surface treatment so as to form a molecular film consisted of molecules each containing the first functional group on the substrate surface. In this way, the present disclosure can enhance the uniformity of the alignment between the self-aligned liquid crystal and the substrate surface and improve the effect of the alignment of the liquid crystal.

### CROSS-REFERENCE TO RELATED APPLICATIONS

The present application is a continuation-application of International (PCT) Patent Application No. PCT/CN2018/077099, filed on Feb. 24, 2018, which claims foreign priority of Chinese Patent Application No. 201810034095.7, filed on Jan. 12, 2018 in the State Intellectual Property Office of China, the entire contents of which are hereby incorporated by reference.

### TECHNICAL FIELD

The present disclosure relates to the technical field of display device, and particularly, to a surface treatment method of a substrate, a substrate, and a liquid crystal display panel.

### BACKGROUND

To the liquid crystal displays in the prior art, additives of small molecular materials such as hydroxysilane in the self-aligning liquid crystals can react with the substrate surface to form hydrogen bonds to achieve the alignment of liquid crystals. However, in the actual production processes, after being etched and a high temperature treatment, the substrate surface has a non-uniform surface roughness, and the hydroxyl on the substrate surface dispersed unevenly and so on, which lead to a weak alignment force between the self-aligned liquid crystal and the substrate surface, and a poor alignment of the liquid crystal.

### SUMMARY

The present disclosure provides a surface treatment method of a substrate, a substrate, and a liquid crystal display panel, which can enhance the uniformity of the alignment between the self-aligned liquid crystal and the substrate surface.

To solve the aforesaid technical problem, a technical solution adopted by the present disclosure provides a surface treatment method of a substrate, including: providing a substrate; providing a first solution containing a compound with a phosphate group, wherein a first functional group of the compound with the phosphate group is a rigid molecular group containing at least one of hydroxyl, amidogen, and carboxyl; immersing the substrate into the first solution for performing a surface treatment so as to form a molecular film consisted of molecules each containing the first functional group on the substrate surface.

To solve the aforesaid technical problem, another technical solution adopted by the present disclosure provides a substrate, including: a transparent substrate and a molecular film consisted of molecules each containing a first functional group and formed on a surface of the transparent substrate; wherein the molecular film is formed by means of immersing the transparent substrate into a first solution to perform a surface treatment, and immersing the transparent substrate after the surface treatment into a first organic solvent to remove the first solution left on the surface of the transparent substrate; wherein the first solution contains a compound with a phosphate group, and the first functional group of the compound with the phosphate group is a rigid molecular group containing at least one of hydroxyl, amidogen, and carboxyl; the first solution is a solution with 0.01˜5 molt concentration, which is obtained by dissolving the compound with the phosphate group into a second organic solvent.

To solve the aforesaid technical problem, another technical solution adopted by the present disclosure provides a liquid crystal display panel, including: an array substrate, a color-film substrate and a liquid crystal layer sandwiched between the array substrate and the color-film substrate; wherein the liquid crystal layer is consisted of self-aligned liquid crystal molecules, the array substrate and/or the color-film substrate include a transparent substrate and a molecular film consisted of molecules each containing a first functional group formed on the surface of the transparent substrate; the molecular film is formed by means of immersing the transparent substrate into a first solution to perform a surface treatment, and the first solution contains a compound with a phosphate group, and the first functional group of the compound with the phosphate group is a rigid molecular group containing at least one of hydroxyl amidogen, and carboxyl.

The present disclosure has the following benefits: it is different from the prior art, in some of the embodiments to the present disclosure immersing the substrate into the first solution containing the compound with the phosphate group for the surface treatment, so as to form the molecular film consisted of molecules each containing the first functional group on the substrate surface. Wherein the first functional group of the compound with the phosphate group is a rigid molecular group containing at least one of hydroxyl, amidogen, and carboxyl. In this way, because the compound with the phosphate group in the first solution has strong binding to the substrate surface, a uniform molecular film consisted of molecules each containing at least one rigid molecular group of hydroxyl, amidogen, and carboxyl can be formed on the surface of the substrate. Consequently, at least one of hydroxyl, amidogen, and carboxyl of the uniform molecular film may be reacted with the additive in the self-aligned liquid crystal and generate the hydrogen bond, to enhance the uniformity of the alignment between the self-aligned liquid crystal and the substrate surface, and improve the effect of the alignment of the liquid crystal.

### BRIEF DESCRIPTION OF THE DRAWINGS

FIG. 1 is a schematic flowchart diagram of a first embodiment of a surface treatment method of a substrate according to the present disclosure;

FIG. 2 is a schematic structural view of a compound with phosphate group according to the present disclosure;

FIG. 3 is a schematic flowchart diagram of the scene of a surface treatment method of a substrate according to the present disclosure;

FIG. 4 is a schematic view of a substrate before the surface treatment and the substrate after the surface treatment according to the present disclosure;

FIG. 5 is a schematic flowchart diagram of a second embodiment of a surface treatment method of a substrate according to the present disclosure;

FIG. 6 is a schematic structural view of an embodiment of a substrate according to the present disclosure;

FIG. 7 is a schematic structural view of an embodiment of a liquid crystal display panel according to the present disclosure.

### DETAILED DESCRIPTION

Hereinbelow, technical solutions of the embodiments of the present disclosure will be described clearly and fully with reference to the attached drawings illustrating the embodiments of the present disclosure. Obviously, the embodiments described herein are only a part of but not all of the embodiments of the present disclosure. All other embodiments that can be obtained by those of ordinary skill in the art from the embodiments of the present disclosure without making creative efforts shall fall within the scope of the present disclosure.

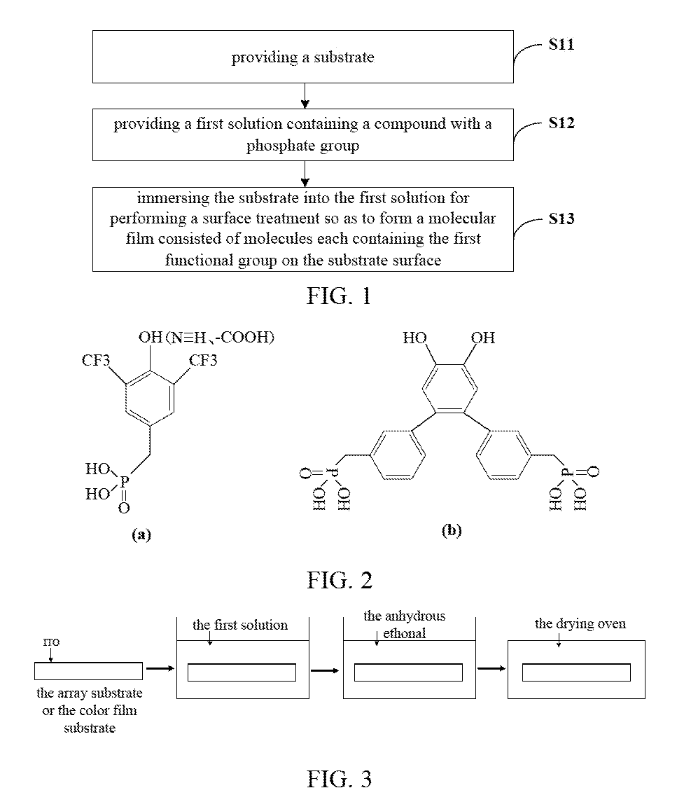

As shown in FIG. 1, a first embodiment of a surface treatment method of a substrate to the present disclosure may include:

S11: providing a substrate.

Wherein the substrate may be an array substrate or a color-film substrate. And the substrate may be an oxide substrate, for example, a metal oxide substrate (such as an ITO substrate) or a SiO substrate (such as a glass substrate).

S12: providing a first solution containing a compound with a phosphate group.

Wherein a first functional group of the compound with the phosphate group is a rigid molecular group containing at least one of hydroxyl, amidogen, and carboxyl.

Optionally, the first solution can be obtained by dissolving the compound with the phosphate group in an organic solvent. The concentration of the first solution may be determined by actual conditions such as the size of the substrate, and there is no limitation on this.

Specifically, in one application example, the first solution with 0.01˜5 mol/L concentration may be obtained by dissolving the compound with the phosphate group into a second organic solvent. Wherein the second organic solvent may be an ethanol solution, such as an anhydrous ethanol solution, since the phosphoric acid is soluble in ethanol. Certainly, the second organic solvent may also be other solvents which can dissolve the compound with the phosphate group, and it is not specifically limited herein.

S13: immersing the substrate into the first solution for performing a surface treatment so as to form a molecular film consisted of molecules each containing the first functional group on the substrate surface.

In this embodiment, the substrate is immersed into the first solution for 0.5˜6 hours, to fully treat the substrate surface, so that a uniform molecular film consisted of molecules each containing the first functional group may be formed on the substrate surface. Certainly, in other embodiments, the time during immersing the substrate into the first solution may be determined by the actual conditions such as the material, size of the substrate, the concentration of the first solution, and there is no limitation on this.

Specifically, referring to FIG. 2˜4, the compound with the phosphate group contains the phosphate group as a main group. And a phosphorus molecule in the phosphate group is linked to the first functional group which is able to react with a liquid crystal. The molecular formula of the compound with the phosphate group is H₂PO₃˜R, wherein the first functional group R— is a rigid molecular group containing at least one of the main functional groups of hydroxyl, carboxyl, and amidogen. The compound with the phosphate group has strong binding to the surface of the oxide substrate (such as ITO, SiO). For example, the phosphate group can react with the hydroxyl and/or oxygen molecule of the substrate surface to generate the hydrogen bond, so that the uniform molecular film may be formed on the surface of the substrate. For example, it is equivalent to forming a layer of the rigid molecular group containing the hydroxyl and uniformly dispersed on the substrate surface, thereby facilitating the uniform dispersion and orientation of the liquid crystal. In addition, the first functional group may also contain a plurality of hydroxyl, carboxyl, or amidogen. Such as the compound in FIG. 2(b), which contains two hydroxyl, thereby enhancing the force between the compound and liquid crystal additives, and further improving the effect of the alignment of the liquid crystal.

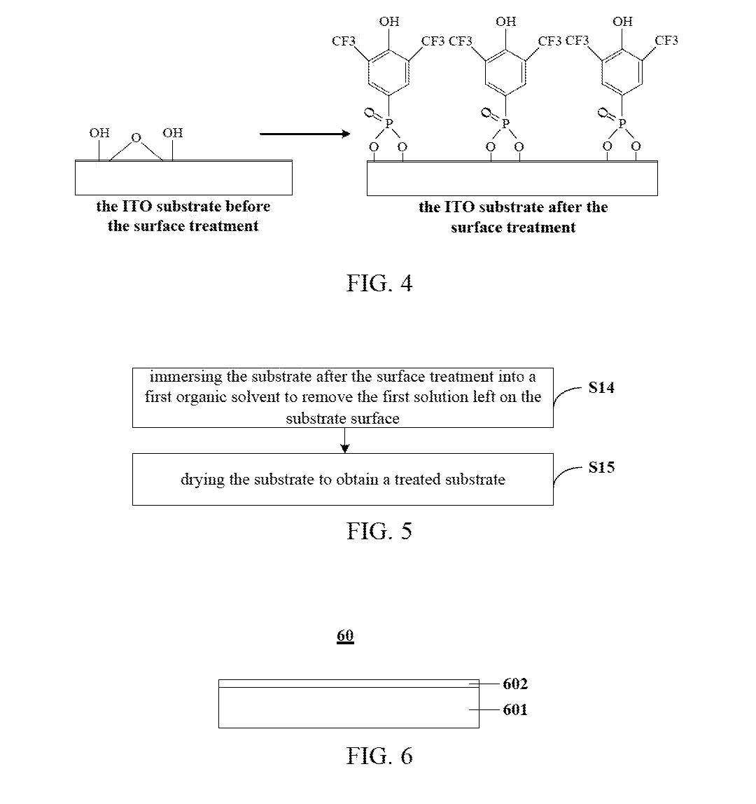

In an application example, as shown in FIG. 3 and FIG. 4 taking ITO substrate as example, the surface of the ITO substrate is treated with the first solution containing the compound as shown in the FIG. 2(a). Before the ITO substrate is treated, there are hydroxyl or oxygen molecules non-uniformly distributing on the surface thereof. The hydroxyl of the phosphate group of the compound as shown in the FIG. 2(a) may be reactive with the hydroxyl and the oxygen molecule on the substrate surface. Finally, a uniform molecular film consisted of molecules each containing the first functional group may be formed on the surface of the treated ITO substrate as shown in the FIG. 4.

The functional group of the first functional group links to the phosphorus molecule through a rigid molecular group (such as the fluorobenzene ring shown in the FIG. 2(a)), and the adoption of the rigid molecular group leads to no reaction between the functional group and the substrate surface. Therefore, after the surface treatment to the substrate, the functional group still queues along the substrate surface (such as the molecular film formed on the surface of the ITO substrate after the surface treatment shown in FIG. 4), which leads to the uniform molecular film formed. During the alignment process of the liquid crystal, the molecular film consisted of molecules each containing the first functional group on the surface of the substrate may be reacted with the hydroxyl class of the additive of the self-aligned liquid crystal and generate the hydrogen bond. Consequently, the liquid crystal can be oriented on the substrate surface without an alignment film, which improve the alignment of the liquid crystal.

In other embodiments, the first functional group may also include other types of group which can easily react with the additive of the self-aligned liquid crystal to generate hydrogen bonds, and there is no limitation on this.

In this embodiment, there may be some of the first solution which is difficult to volatile left on the substrate surface after the surface treatment. And in other embodiments, an organic solvent may be used to remove the first solution left to avoid an impact made by the first solution on subsequent processes.

As shown in FIG. 5, a second embodiment of a surface treatment method of a substrate to the present disclosure is based on the first embodiment. After the block S13 the second embodiment further includes:

S14: immersing the substrate after the surface treatment into a first organic solvent to remove the first solution left on the substrate surface.

Wherein the first organic solvent is an ethonal solution (such as an anhydrous ethonal solution). The time during the surface-treated substrate is immersed into the first organic solvent may depend on the type, concentration of the first organic solvent, or other facts, and there is no limitation on this.

Specifically, the phosphoric acid is easy to be dissolved into the ethonal, and the anhydrous ethonal is easy to volatile not to left on the substrate, which may not affect the follow up. Consequently, combined with FIG. 3, immersing the substrate after the surface treatment into the anhydrous ethonal solution to remove the first solution left on the substrate, to avoid the affect made by the first solution left on the follow-up process. Certainly, in other embodiments, the first organic solvent may be other solvents which can remove the first solution, and it is not specifically limited herein.

Optionally, after the block S14, the second embodiment may further includes:

S15: drying the substrate to obtain a treated substrate.

Wherein hot air box, drying oven and so on may be used to dry the substrate. The time and temperature for drying the substrate may depend on actual demands, and there is no limitation on this.

Specifically, in an application example, combined with FIG. 3. After removing the first solution on the substrate surface, the substrate may be placed into a drying oven and be dried with a temperature of 100˜200 degrees centigrade for 5 minutes to 1 hour to obtain the treated substrate. The first organic solvent can be removed from the substrate surface after the drying process, and the molecular film on the substrate surface may be more firmly bonded to the substrate, which may facilitate the follow-up process of the alignment of the liquid crystal.

As shown in FIG. 6, an embodiment of a substrate 60 to the present disclosure may include: a transparent substrate 601 and a molecular film 602 consisted of molecules each containing a first functional group, wherein the molecular film 602 is formed on a surface of the substrate.

Wherein, the transparent substrate 601 may be an array substrate or a color-film substrate. And the transparent substrate 601 may be oxide substrate, for example, a metal oxide substrate (such as an ITO substrate), or a SiO substrate (such as a glass substrate).

Preparation methods of the molecular film 602 may refer to the methods provided in the first or second embodiment of the surface treatment method of a substrate to the present disclosure. And it is not repeated here.

In this embodiment, the molecular film consisted of molecules each containing the first functional group and formed on the substrate surface may react with the hydroxyl class of the additive of the self-aligned liquid crystal and generate a hydrogen bond. Consequently, the liquid crystal may get oriented on the substrate surface without the alignment film, which may improve the alignment of the liquid crystal. And the uniform distribution of the first functional group in the molecular film may facilitate the uniform dispersion and alignment of the self-aligned liquid crystal.

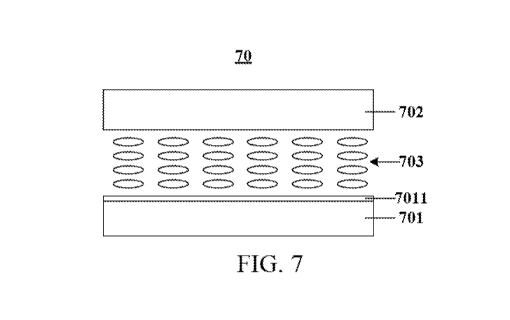

As shown in FIG. 7, an embodiment of a liquid crystal display panel 70 to the present disclosure may include: an array substrate 701, a color-film substrate 702 and a liquid crystal layer 703 sandwiched between the array substrate 701 and the color-film substrate 702.

Wherein the liquid crystal layer 703 is self-aligned liquid crystal, and the allay substrate 701 and/or the color-film substrate 702 may adopt the structure in the embodiments of the substrate to the present disclosure, and it is not repeated here.

Specifically, a molecular film (such as a molecular film 7011 on the array substrate 701 as shown in FIG. 7) consisted of molecules each containing a first functional group may be formed on the surface of at least one of the array substrate 701 and the color-film substrate 702, and the self-aligned liquid crystal contains an additive. After the self-aligned liquid crystal being injected between the array substrate 701 and the color-film substrate 702, the group such as hydroxyl of the additive may react with the molecular film on the surface of the array substrate 701 and/or the color-film substrate 702 and generate the hydrogen bond. Consequently, the liquid crystal may get oriented on the surface of the array substrate 701 and/or the color-film substrate 702 without the alignment film. And the uniform distribution of the first functional group in the molecular film may facilitate the uniform dispersion and alignment of the self-aligned liquid crystal.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

What is claimed is:

1. A Substrate, comprising:
transparent substrate and a molecular film consisted of molecules each containing a first functional group and formed on a surface of the transparent substrate;
wherein the molecular film is formed by means of immersing the transparent substrate into a first solution to perform a surface treatment, and immersing the transparent substrate after the surface treatment into a first organic solvent to remove the first solution left on the surface of the transparent substrate;
wherein the first solution contains a compound with a phosphate group, and the first functional group of the compound with the phosphate group is a rigid molecular group containing at least one of hydroxyl, amidogen, and carboxyl;
the first solution is a solution with 0.01˜5 mol/L concentration, which is obtained by dissolving the compound with the phosphate group into a second organic solvent.

2. The substrate of claim 1, wherein the substrate is obtained by drying the transparent substrate after immersing the surface-treated transparent substrate into the first organic solvent to remove the first solution left on the surface thereof.

3. The substrate of claim 2, wherein the substrate is obtained by drying the transparent substrate in a drying oven with a temperature of 100—200 degrees centigrade for 5 minutes to 1 hour.

4. The substrate of claim 1, wherein the first organic solvent is an anhydrous ethonal solution.

5. The substrate of claim 1, wherein the molecular film is a film consisted of molecules each containing the first functional group, and is formed on the surface of the transparent substrate after the surface treatment which immerse the transparent substrate into the first solution for 0.5˜6 hours.

6. The substrate of claim 1, wherein the transparent substrate is an oxide substrate.

7. A surface treatment method of a substrate, comprising:
providing a substrate;
providing a first solution containing a compound with a phosphate group, wherein a first functional group of the compound with the phosphate group is a rigid molecular group containing at least one of hydroxyl, amidogen, and carboxyl;
immersing the substrate into the first solution for performing a surface treatment so as to form a molecular film consisted of molecules each containing the first functional group on the substrate surface.

8. The method of claim 7, wherein after immersing the substrate into the first solution for performing a surface treatment so as to form a molecular film consisted of molecules each containing the first functional group on the substrate surface, the method further comprises:
immersing the substrate after the surface treatment into a first organic solvent to remove the first solution left on the substrate surface.

9. The method of claim 8, wherein after immersing the substrate after the surface treatment into a first organic solvent to remove the first solution left on the substrate surface, the method further comprises:
drying the substrate to obtain a treated substrate.

10. The method of claim 9, wherein the block of drying the substrate to obtain a treated substrate, comprises:
placing the substrate into a drying oven with a temperature of 100˜200 degrees centigrade for 5 minutes to 1 hour, to obtain the treated substrate.

11. The method of claim 8, wherein, the first organic solvent is an anhydrous ethonal solution.

12. The method of claim 7, wherein the block of providing a first solution containing a compound with a phosphate group, comprises:
obtaining the first solution with 0.01˜5 mol/L concentration by dissolving the compound with the phosphate group into a second organic solvent.

13. The method of claim 7, wherein the block of immersing the substrate into the first solution for performing a surface treatment so as to form a molecular film consisted of molecules each containing the first functional group on the substrate surface, comprises:
immersing the substrate into the first solution for 0.5˜6 hours to perform the surface treatment for the substrate so as to form the molecular film consisted of moleculars each containing the first functional group on the substrate surface.

14. The method of claim 7, wherein, the substrate is an oxide substrate.

15. A liquid crystal display panel, comprising an array substrate, a color-film substrate and a liquid crystal layer sandwiched between the array substrate and the color-film substrate;
wherein the liquid crystal layer is consisted of self-aligned liquid crystal molecules, the array substrate and/or the color-film substrate comprise a transparent substrate and a molecular film consisted of molecules each containing a first functional group formed on the surface of the transparent substrate;
the molecular film is formed by means of immersing the transparent substrate into a first solution to perform a surface treatment, and the first solution contains a compound with a phosphate group, and the first functional group of the compound with the phosphate group is a rigid molecular group containing at least one of hydroxyl, amidogen, and carboxyl.

16. The liquid crystal display panel of claim 15, wherein the array substrate and/or the color-film substrate are obtained by immersing the transparent substrate after the surface treatment into a first organic solvent to remove the first solution left on the surface of the transparent substrate.

17. The liquid crystal display panel of claim 15, wherein the array substrate and for the color-film substrate are obtained by drying the transparent substrate after immersing the surface-treated transparent substrate into the first organic solvent to remove the first solution left on the surface thereof.

18. The liquid crystal display panel of claim 17, wherein drying the transparent substrate is placing the transparent substrate into a drying oven with a temperature of 100˜200 degrees centigrade for 5 minutes to 1 hour.

19. The liquid crystal display panel of claim 18, wherein the time during immersing the transparent substrate into the first solution is 0.5˜6 hours.

20. The liquid crystal display panel of claim 15, wherein, the first solution containing the compound with the phosphate group is a solution with 0.01˜5 mol/L concentration, which is obtained by dissolving the compound with the phosphate group into a second organic solvent.
